(19) United States
(12) Patent Application Publication
(10) Pub. No.: US 2026/0312917 A1
(43) Pub. Date: Oct. 8, 2026

(54) PACKET SCHEDULING WITH ROUTING AWARENESS

(71) Applicant: NOKIA SOLUTIONS AND NETWORKS OY, Espoo (FI)

(72) Inventor: Andrea FRANCINI, Chapel Hill, NC (US)

(21) Appl. No.: 19/172,017

(22) Filed: Apr. 7, 2025

(51) Int. Cl. H04L 47/62

(52) U.S. Cl. CPC H04L 47/6215

(57) ABSTRACT

An apparatus and method to schedule a transmission of packets in a network from a set of queues using a periodic service sequence including a set of timeslots, wherein each queue of the set of queues is associated with one or more respective timeslots from the set of timeslots, an associated path from a set of paths in the network, and an associated queue credit, wherein each path of the set of paths is associated with a respective path credit, and wherein packet transmissions from each queue is controlled by the associated queue credit and the respective path credit of the associated path.

### FIELD OF THE DISCLOSURE

Various example embodiments disclosed herein relate to methods and devices for packet scheduling with routing awareness.

### BACKGROUND

In packet-switched networking, determinism expresses the ability of a network domain to consistently deliver data packets to their intended destinations at exact times. Absolute determinism, where there is no difference between actual and pre-defined delivery time, is not feasible in practice at reasonable cost. However, it can be approximated by allowing the packet deliveries to happen within time intervals that are tight enough to satisfy the requirements of the respective applications. This close approximation of absolute determinism is realized when the network minimizes the primary source of variability in the end-to-end packet latency, which is the accumulation of relatively large queues of packets waiting to be transmitted over the network links. Queuing latency is the performance metric that is minimized to achieve a usable approximation of network determinism.

### SUMMARY

A summary of various example embodiments is presented below.

Various embodiments relate to an apparatus, comprising: at least one processor; and at least one memory including a set of instructions, wherein the set of instructions, when executed by the at least one processor, cause the apparatus to at least: schedule a transmission of packets in a network from a set of queues using a periodic service sequence including a set of timeslots, wherein a queue of the set of queues is associated with one or more respective timeslots from the set of timeslots, an associated path from a set of paths in the network, and an associated queue credit, wherein the associated path of the set of paths is associated with a respective path credit, and wherein scheduling packet transmissions from the queue is controlled by the associated queue credit and the respective path credit of the associated path.

Various embodiments are described, wherein an amount of packet transmissions permitted from the queue during the associated one or more respective timeslots is indicated by the respective path credit of the associated path.

Various embodiments are described, wherein the amount of packet transmissions permitted from the queue during the associated one or more respective timeslots is indicated by the associated queue credit.

Various embodiments are described, wherein the associated path has a respective path credit counter configured to track the respective path credit of the associated path.

Various embodiments are described, wherein the queue has a respective queue credit counter configured to track the associated queue credit of the queue.

Various embodiments are described, wherein the queue comprises a first queue and wherein scheduling the transmission of packets further comprises: identifying a first timeslot in the periodic service sequence, the first timeslot being associated with the first queue; increasing the respective path credit counter of the associated path of the first queue; increasing the respective queue credit counter of the first queue; determining whether the first queue is eligible for transmission based upon the first queue being real and nonempty and upon the respective path credit counter of the associated path of the first queue and the respective queue credit counter of the first queue; and based on determining that the first queue is eligible for transmission, scheduling the transmission of packets from the first queue.

Various embodiments are described, wherein scheduling the transmission of packets further comprises: determining whether the first queue is a real queue before increasing the respective path credit counter of the associated path of the first queue and before increasing the respective queue credit counter of the first queue; and identifying a second timeslot in the periodic service sequence and an associated second queue based upon determining that the first queue is not eligible for transmission.

Various embodiments are described, wherein scheduling the transmission of packets further comprises: decreasing the respective path credit counter of the associated path of the first queue and decreasing the respective queue credit counter of the first queue based upon determining that the first queue is eligible for transmission.

Various embodiments are described, wherein decreasing the respective path credit counter of the associated path of the first queue and the respective queue credit counter of the first queue is based upon a packet transmission time.

Various embodiments are described, wherein decreasing the respective path credit counter of the associated path of the first queue and wherein decreasing the respective queue credit counter of the first queue is further based upon a number of timeslots in the periodic service sequence.

Various embodiments are described, wherein scheduling the transmission of packets further comprises: based upon determining that the first queue is not eligible for service: identifying a second timeslot in the periodic service sequence, the second timeslot being associated with a second queue from the set of queues, wherein the second timeslot is a next timeslot after the first timeslot; determining whether the second queue is eligible for service; and based upon determining that the second queue is eligible for transmission, scheduling the transmission of packets from the second queue.

Various embodiments are described, wherein scheduling the transmission of packets further comprises: determining whether the second queue is real; based upon determining that the first queue is not eligible for service and based upon determining that the second queue is real, and before determining whether the second queue is eligible for service: increasing the path credit counter of the associated path of the second queue; and increasing the associated queue credit counter of the second queue.

Various embodiments are described, wherein scheduling the transmission of packets further comprises: decreasing the path credit counter of the associated path of the second queue and decreasing the associated queue credit counter of the second queue based upon determining that the second queue is eligible for transmission.

Various embodiments are described, wherein: increasing the respective path credit counter of the associated path of the first queue is based upon an amount of time since the respective path credit counter of the associated path of the first queue was last updated; and increasing the associated queue credit counter of the first queue is based upon an amount of time since the associated queue credit counter of the first queue was last updated.

Various embodiments are described, wherein: increasing the respective path credit counter of the associated path of the first queue is further based upon a number of timeslots that are allocated to the associated path of the first queue within the periodic service sequence; and increasing the associated queue credit counter of the first queue is further based upon a number of timeslots that are allocated to the first queue within the periodic service sequence.

Various embodiments are described, wherein determining whether the first queue is eligible for service further comprises: determining whether the respective path credit counter of the associated path of the first queue and the associated queue credit counter of the first queue are both nonnegative; or determining whether the respective queue credit counter of the associated path of the first queue is larger than a path-override credit threshold.

Various embodiments are described, wherein scheduling the transmission of packets further comprises: based up determining that the first queue is not eligible for service: determining whether a second queue associated with a second timeslot of the set of timeslots is eligible for service, wherein the second timeslot is a next timeslot after the first timeslot; based upon determining that the second queue of the second timeslot is not eligible for service, determining whether a lower-priority queue is ready for service; and based upon determining that the lower-priority queue is ready for transmission, scheduling the transmission of packets from the lower-priority queue.

Various embodiments are described, wherein scheduling the transmission of packets further comprises: eliminating scheduling the transmission of packets, based upon determining that no lower-priority queue is ready for transmission.

Various embodiments are described, wherein the respective path credit counter of the associated path of the queue and the respective queue credit counter of the queue are initialized based on a time duration of the periodic service sequence.

Further various embodiments relate to a method, comprising: initializing a set of path credit counters; initializing a set of queue credit counters; and scheduling a transmission of packets in a network from a set of queues using a periodic service sequence including a set of timeslots, wherein the scheduling is based upon the set of path credit counters and the set of queue credit counters, wherein a queue of the set of queues is associated with one or more respective timeslots from the set of timeslots, an associated path from a set of paths in the network, and an associated queue credit counter of the set of queue credit counters, wherein the associated path is associated with a respective path credit counter of the set of path credit counters, and wherein packet transmission from the queue is based upon the respective path credit counter of the associated path and the associated queue credit counter.

Various embodiments are described, wherein the respective path credit counter of the associated path and the associated queue credit counter are indicative of amounts of transmission permitted from the queue during the one or more respective timeslots.

Various embodiments are described, wherein the queue comprises a first queue and wherein scheduling the transmission of packets further comprises: identifying a first timeslot in the periodic service sequence and the first timeslot being associated with the first queue; increasing the respective path credit counter of the associated path of the first queue; increasing the associated queue credit counter of the first queue; determining whether the first queue is eligible for service based upon the respective path credit counter and the associated queue credit counter; and based on determining that the first queue is eligible for transmission, transmitting a packet from the first queue.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example of mapping of a logical topology of a network onto a corresponding shaping hierarchy.

FIG. 2 illustrates an example embodiment of a periodic service sequence (PSS) that drives the operation of a time-division multiplexing (TDM) frame scheduler.

FIG. 3 illustrates a flow chart of an example embodiment for the general operation of a TDM-with-path-credit scheduler.

FIG. 4 illustrates a flow chart of the execution of a scheduling decision according to some embodiments of the disclosure.

FIG. 5 illustrates an example hardware diagram for implementing a TDM-with-path-credit scheduler according to some embodiments of the disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The embodiments of the present disclosure provide for the minimization of queuing latency in packet-switched networks of generic size and topology. Example embodiments of the framework can confine, at the ingress edge of the network, a traffic shaping function configured to allow ultra-low upper bounds on queuing latency throughout the network (a traffic shaping function is a packet scheduler that enforces configurable upper bounds on the packet transmission rates experienced by the packet queues that it serves). In the middle of the network, embodiments of the framework serve per-class first-in-first-out (FIFO) queues in strict-priority order making new packet scheduling capabilities unnecessary. Embodiments of the traffic shaping algorithm that the framework applies to the ingress links of the network, embed a notion of routing awareness that ensures that packets destined for any interior link of the network are transmitted over the ingress links at times that are within a close approximation of evenly spaced. This avoids the formation of long packet queues and therefore the accumulation of large queuing latency in the network nodes. In some embodiments, the algorithm that assigns the evenly spaced transmission opportunities to deterministic traffic flows can be executed offline to facilitate traffic shaping operation at high end link rates such as, for example, 10 Gb/s and higher. One result of the offline execution can be a periodic service sequence (PSS) that drives the run-time operation of a time-division multiplexing (TDM) scheduler for each instance of the ingress-link shaper.

The embodiments of the present disclosure disclose a TDM scheduler for improvement of the latency and fairness performance of the an overall framework intended to reduce latency. Specifically, the embodiments of the present disclosure introduce routing awareness in the operation of the TDM scheduler in addition to a routing awareness embedded in a shaping algorithm whose offline execution configures the periodic service sequence of the TDM scheduler.

Several aspects of packet scheduling methods and systems with routing awareness will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Various approaches to guarantee upper bounds on end-to-end latency have been proposed. Some of the end-to-end latency guarantees are those enforced by a network path fully equipped with weighted fair queuing (WFQ) schedulers. Without including the burstiness contribution from the packet source, the end-to-end latency bound for a flow i is approximately Nᵢ·Lᵢ/rᵢ, where Niᵢ the number of WFQ schedulers traversed by the flow, each scheduler serving the flow at rate rᵢ, and Lᵢ is the size of the largest packet of flow i. In order for the bound to hold, flows can be explicitly provisioned and assigned a dedicated queue at all interior nodes, but the signaling and provisioning steps associated with this strategy may create overhead that is not easily sustainable in a large-scale network (a large-scale network is composed of at least a few switching nodes and may be required to simultaneously support tens of deterministic flows or more).

Scheduling of per-class queues is another available approach. In some solutions for network determinism, the class queues that handle deterministic traffic are served with top priority but, in order to avoid starvation of the lower-priority traffic and the formation of traffic bursts within the top-priority class, they may also be shaped. While the actual implementation of the shaper may vary, shaping of a class queue homogenizes the latency guarantees of all flows handled by the queue, moving them to the upper end of the range of latency requirements of the individual flows.

Some solutions imply scheduling or shaping contributions from the interior nodes. However, supporting the scheduling behavior and keeping the interior nodes provisioned with the parameters that control the operation of the scheduler in this approach may lead to increased complexity and cost and may lead to frequent updates of these parameters for the internal nodes, creating again a signaling and provisioning overhead that may not be easily sustainable in a large-scale network.

Simulation experiments and a proof-of-concept system that emulates a small data center fabric prove that the framework can enforce reduced bounds on end-to-end latency. For example, the framework can keep the maximum latency well below 30 μs in a three-stage data center fabric with 10 Gb/s links all utilized at 96% of capacity, while the common approach of plainly overprovisioning the link capacity exceeds 300 μs at 9.6% link utilization (i.e., the framework enables a 10× reduction of the worst-case latency with a 10× increase in network utilization).

In a per-flow shaper with a hierarchy of shaping nodes based upon the network topology, the hierarchy embeds routing awareness in the traffic shaping function, preventing the transmission of sustained trains of back-to-back packets from any ingress link of the network to any interior link of the network. Avoiding these trains of back-to-back packets avoids the formation of long packet queues in the packet buffers of the switching nodes.

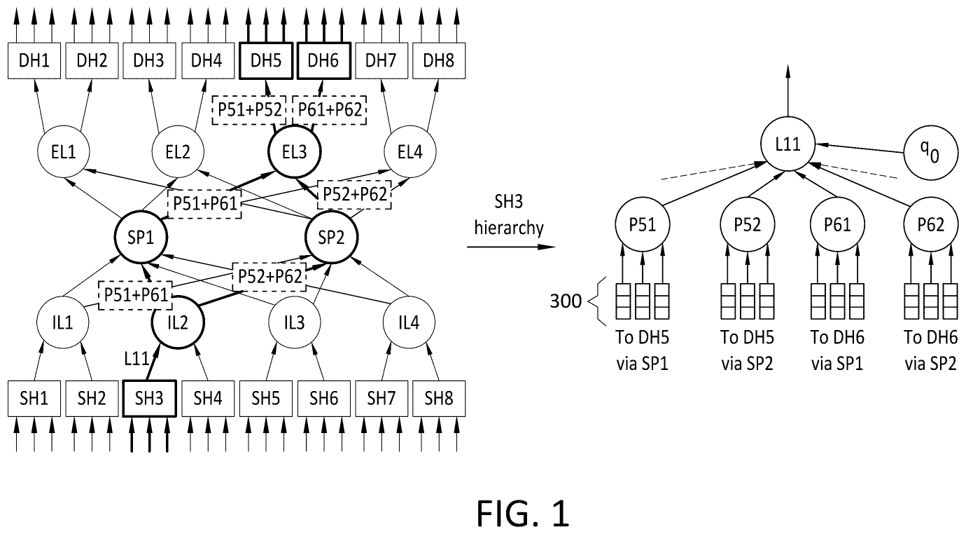

FIG. 1 illustrates an example of mapping of a logical topology of a network onto a corresponding shaping. In FIG. 1, the SH's are source hosts where the shaper is instantiated; the IL's are ingress-leaf switches of a leaf-spine topology for data-center switch fabrics; the SP's are spine switches in the same topology; the EL's are egress leaves in the same topology; the DH's are destination hosts; the L's are network links; the P's are network paths between source and destination hosts; and q₀ is a virtual empty queue of the shaper, with service rate equal to the portion of link capacity not yet allocated to actual flows. The right-hand side of the figure shows the two-layer hierarchy of the shaper. The mapping of FIG. 1 leads to a universal method for construction of the shaping hierarchy that works for any network topology and for any feasible distribution of the deterministic flows over the available network paths (a feasible distribution of deterministic flows is one where the sum of the bandwidth allocations for the deterministic flows that traverse each network link never exceeds the capacity of the link).

An additional optional scheduling layer may be added to the bottom of the shaping hierarchy for deterministic flows with ultra-low latency requirements and relatively low throughput requirements, such that their admission to the network does not translate into an excessive subtraction of bandwidth resources from the pool available for the provisioning of other deterministic flows.

The embodiments of the present disclosure enhance the latency and fairness performance of a method for operating a TDM. The following description summarizes a TDM scheduler, which throughout the rest of this document is referred to as the TDM-with-timeslot-credits (TDM-TC) scheduler.

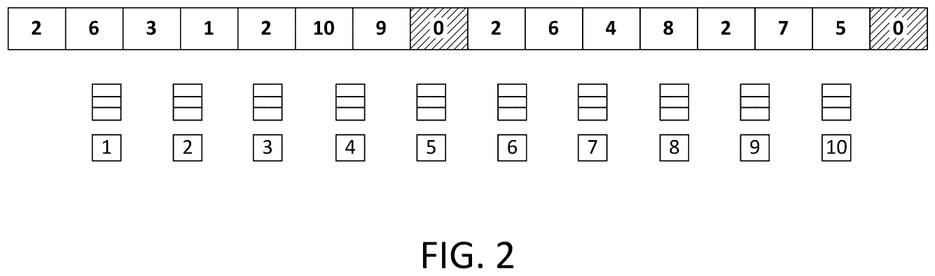

The TDM-TC scheduler assigns services to packet queues based on a pre-computed periodic service sequence (PSS). The TDM-TC scheduler achieves accurate enforcement of throughput guarantees through a novel credit accounting method where credits are associated with the timeslots of the service sequence and not directly with the packet queues that are served by the scheduler. FIG. 2 illustrates an example embodiment of a periodic service sequence (PSS) that drives the operation of the TDM frame scheduler. The PSS is divided into timeslots of fixed duration; each timeslot is associated with a packet queue through the identifier of the queue. Queue 0 is the virtual empty queue of FIG. 1. Timeslots assigned to the virtual empty queue are passed to a queue associated with a lower-priority traffic class.

The TDM-TC scheduler uses credit counters to ensure that service lost to a transmission time spillover from a previous timeslot does not translate into a violation of throughput guarantees in both the short and the long term. A way to handle the credit counters would be to associate them with the queues and then allow queues with positive credits to grab service time from the timeslots that immediately precede and follow their designated service timeslots. However, this straightforward approach may fail to achieve short-term and long-term enforcement of throughput guarantees because it can systematically grab transmission time from one queue to compensate transmission time lost to another queue. The idea of the TDM-TC scheduler is the association of credit counters with the timeslots of the scheduler and not with the queues that they serve. This way the compensation of service times occurs within the queue pairs where the service spillovers occur, without involving other queues.

The TDM-TC scheduler achieves excellent performance in terms of fairness in the distribution of service to the flow queues and of the latency experienced by the packets stored in the same flow queues. However, when multiple instances of the scheduler are deployed at respective ingress links of a network domain that implements the low-latency framework of the per-flow shaper with a hierarchy of shaping nodes, small temporary service unfairness at the queue level can translate into larger unfairness among the flow aggregates of the shaping hierarchy specified in the mapping of a logical topology of a network onto a corresponding shaping of FIG. 1. The traffic aggregate unfairness may in turn translate into larger queuing latency throughout the network domain. The unfairness at the level of routing-defined traffic aggregates is more evident when the service spillover allowed by the TDM-TC scheduler is larger compared to the duration of the TDM timeslot. Accordingly, the latency degradation induced by the unfairness grows with the ratio between the maximum amount of bytes that can be transmitted back-to-back out of the same flow queue and the amount of bytes that can be transmitted during the nominal duration of a TDM timeslot. As an example, when the timeslot duration is the time needed to transmit 1600 bytes, if all packets have size 1542 bytes once transmitted over the Ethernet link that is controlled by the scheduler, then the maximum difference between allowed back-to-back bytes and timeslot duration is 1542+1542−1600=1484 bytes, with a ratio of 1484/1600=0.93 between spillover bytes and timeslot size. Instead, if the maximum size of a packet transmitted over the Ethernet link is 870 bytes, then the maximum difference between allowed back-to-back bytes and timeslot duration is 870+870−1600=140 bytes, yielding a ratio 140/1600=0.09 between spillover bytes and the timeslot size. The temporary traffic-aggregate unfairness, and therefore the latency degradation, can be expected to be much smaller in the latter case.

Prior frameworks for the enforcement of ultra-low bounds on end-to-end queuing latency in wired networks of any size and topology have been shown to be sensitive to the size of the deterministic packets that traverse the network. More specifically, it is sensitive to the relationship between the packet size and the duration of the timeslot in the TDM schedulers of the ingress links.

The sensitivity to the packet size derives from the short-term unfairness that can characterize the distribution of service to individual queues in the operation of the TDM-TC scheduler. While that unfairness is short-lived and quantitatively marginal when measured for pairs of queues, it can become more relevant for traffic aggregates associated with groups of queues that send packets through the same set of interior links of the network. Such cumulative amount of excess services received by queues of flows with common routing paths can produce perceivable effects on the maximum queuing latency of packets that traverse the network.

The embodiments of the present disclosure describe a TDM scheduler that reduces the accumulation of service unfairness at the level of per-routing-path traffic aggregates through explicit control, with the end result of consistently keeping the end-to-end latency within the estimated bounds, independently of the size of the deterministic packets.

The embodiments of the present disclosure define a TDM-with-path-credit (TDM-PC) scheduler that introduces three features of operation that result in improved latency performance.

First, the TDM-PC scheduler introduces network path credits. Every time a queue is considered for service during a timeslot, the available credits of the network path that the queue is associated with are checked. If positive credits are found, the queue can be considered for service. Negative network-path credits lower the chances for the queue to be selected. The purpose of network-path credits is to prevent the transmission of excessive amounts of back-to-back packets to a given network path, which is the primary cause of accumulation of queuing latency in the middle of the network.

Second, the embodiments introduce queue credits. The use of queue credits is made necessary by the introduction of network-path credits, because queues map directly onto network paths, while timeslots do not.

Third, the embodiments introduce a path-override credit threshold (POCT). A queue whose network path has negative credits can still be selected for service if its queue credits are larger than the POCT. The purpose of the POCT is to ensure that a queue that belongs to a network path that has recently received services in excess of its guaranteed rate is not penalized if it has not received a service in a relatively long time. The POCT enables better service fairness among queues that use the same network path.

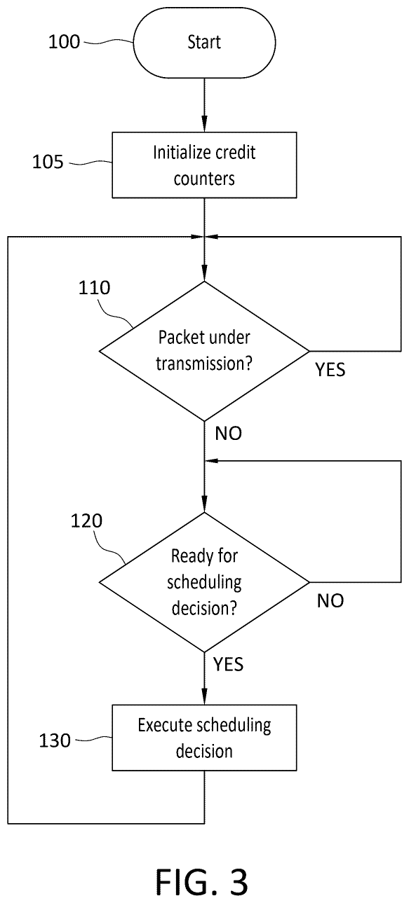

FIG. 3 illustrates a flow chart of an example embodiment for the general operation of a TDM-PC scheduler. Specifically, the TDM-PC scheduler replaces the timeslot credit counter of the TDM-TC scheduler with a path credit counter (PCC) and a queue credit counter (QCC). The PSS of the TDM-PC associates each timeslot with a queue, which in turn is associated with the network path of the respective deterministic flow.

In FIG. 3, the TDM-PC operation starts at step 100, then proceeds to step 105, where the TDM-PC scheduler initializes the credit counters, namely the PCC of the network paths and the QCC of the queues. In one embodiment, credits are expressed in time units (e.g., nanoseconds or picoseconds) and the PCC and QCC counters are identically initialized to the total duration of the PSS, which may be calculated as TimeslotDuration*TotalNumberOfTimeslots. In a second embodiment, credits are also expressed in time units and may be initialized proportionally to AllocatedTimeslots, the number of timeslots assigned within the entire PSS to the path or queue: TimeslotDuration*AllocatedTimeslots (the ratio AllocatedTimeslots/TotalNumberOfTimeslots expresses AllocatedNormalizedServiceRate, the service rate of the path or queue normalized by the link capacity).

The TDM-PC scheduler then proceeds to step 110, where it checks if a packet is currently under transmission. If a packet is currently under transmission, the scheduler cannot select a new packet for transmission and returns to step 110. If no packet is under transmission, the scheduler moves to step 120, where it checks if a new scheduling decision can be made. The transmission of a packet and the execution of the next scheduling decision may be spaced, for example, by at least a fixed amount of time, so the scheduler may be ready for a new scheduling decision only after that amount of time has elapsed since the completion of the previous packet transmission. The fixed amount of time between the completion of a packet transmission and the execution of the next scheduling decision may be equal, for example, to the inter-packet gap between consecutive packets transmitted over the network link of the scheduler. Ethernet, for example, uses interpacket gaps, so that a packet may not be transmitted if the inter-packet gap has not expired since completion of the last packet transmission. In other embodiments, the time between the completion of a packet transmission and the execution of the next scheduling decision may be variable. Other factors, such as timing and execution delays, may come into play to decide when the next packet transmission can be scheduled.

If, at step 120, the scheduler is not ready for a scheduling decision, it returns to step 120. Otherwise, the scheduler proceeds to step 130, where it executes the scheduling decision. After the execution of the scheduling decision is complete, the scheduler returns to step 110.

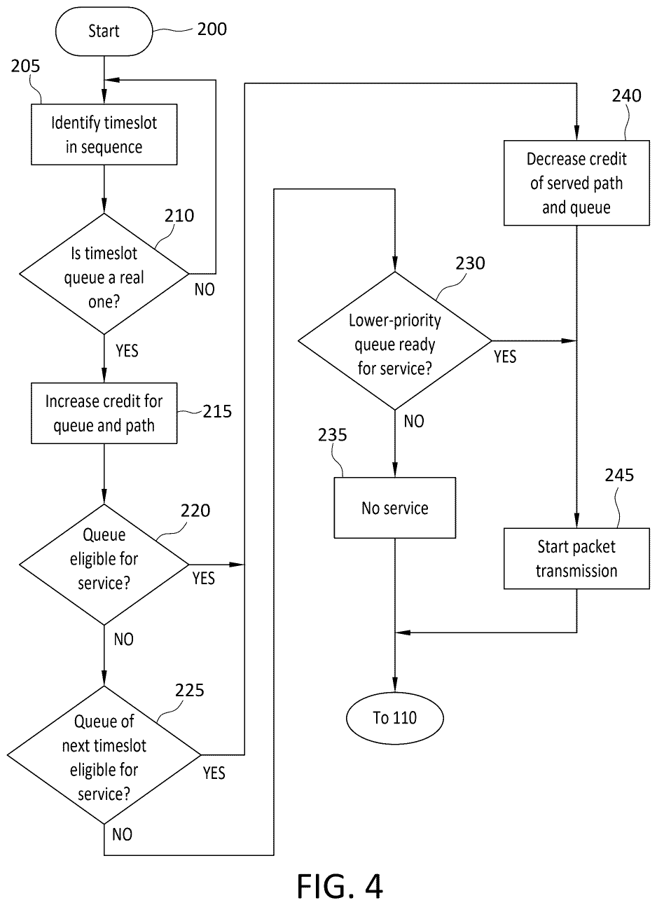

FIG. 4 illustrates a flow chart of the execution of a scheduling decision according to some embodiments of the disclosure. The TDM-PC scheduler starts the scheduling decision at step 200, then proceeds to step 205, where the TDM-PC scheduler identifies the PSS timeslot that corresponds to the current time. The identification of the timeslot k is determined by the value of the current time t, the duration of a timeslot T (also referred to as TimeslotDuration), and the total number of timeslots N in the service sequence (also referred to as TotalNumberOfTimeslots), as k=(t%(N·T))/T, where % is the modulo operator (t and T are expressed in identical time units, e.g., nanoseconds). The TDM-PC scheduler then proceeds to step 210, where it verifies if the queue of the identified timeslot is a real one or the virtual empty queue. For example, the virtual empty queue may result when the service rate requirements of the allocated flows have not used up all of the available bandwidth of the link. If the queue of the identified timeslot is the virtual empty queue, the TDM-PC scheduler returns to step 205, where the identified timeslot may or may not be the same, depending on the time elapsed since the previous execution of step 205. Otherwise, it proceeds to step 215.

At step 215, the TDM-PC scheduler increases the credit counters for the queue (QCC) and path (PCC) of the identified timeslot. In one embodiment, the credit increase is equal to the extents of time elapsed since the previous credit updates for the same queue and path, multiplied respectively by the number of timeslots that the queue and the path have been assigned within the entire PSS upon their configuration (i.e., DeltaTime*AllocatedTimeslots, where DeltaTime is the time since the previous credit update for the same queue or path and AllocatedTimeslots is the number of timeslots that are allocated to the same queue or path within the entire periodic service sequence). In a second embodiment, the time DeltaTime since the previous credit update is multiplied by the product of AllocatedTimeslots and AllocatedNormalizedServiceRate. In both embodiments, the larger the service rate allocated to a queue or path, the larger the number of timeslots that are assigned to it, and the faster the replenishment of its credits. Generally, when a credit counter is updated, the time of the update is saved in a variable associated with the credit counter, and this time can later indicate how long it has been since the counter was last updated. After adding the credit increment to the previous value of the credit counter, the TDM-PC scheduler sets the credit counter equal to the minimum of its new value and the total duration TimeslotDuration*TotalNumberOfTimeslots of the PSS (in one embodiment of the disclosure), or the minimum of its new value and the product AllocatedTimeslots*TimeslotDuration (in a second embodiment). Similar rules apply to the PCC and the QCC, any difference between them being in the values of the respective instances of AllocatedTimeslots and AllocatedNormalizedServiceRate, which are generally larger for the PCC versus the QCC. The TDM-PC scheduler then proceeds to step 220.

At step 220, the TDM-PC scheduler determines if the queue of the current timeslot can be considered for service. This is the case if the queue has at least one queued packet and one of the following conditions is true:
the PCC and QCC are both nonnegative; or
the QCC is not smaller than the nonnegative path-override credit threshold (POCT).
   Upon initialization of all scheduler variables, the POCT value is set to a nonnegative value, typically a fraction of the maximum credit value allowed for the QCC; in one embodiment, where the maximum credit value is identical for all paths and queues and equal to the total duration of the PSS, and the POCT value is identical for all queues. For example, the POCT value may be set equal to one fourth of the PSS duration: POCT=(N·T)/4. However, other values may be used as well. Instead, in a second embodiment where the maximum value of QCC for each queue is equal to the product AllocatedTimeslots*TimeslotDuration, the POCT may be set equal to the product of the maximum credit value, which may be different for every queue, and a fixed nonnegative number not larger than 1 (for example, POCT(Queue i)=AllocatedTimeslots(Queue i)*TimeslotDuration/4).

If the TDM-PC scheduler determines, at step 220, that the queue of the current timeslot is eligible for service, it selects the queue for service and proceeds to step 240, otherwise it moves to step 225.

At step 225, if the next timeslot holds a real queue, the TDM-PC scheduler updates the QCC of the queue of the next timeslot and the PCC of the corresponding path. Then it checks if the queue of the next timeslot in the PSS is eligible for service. This is the case if the queue satisfies all the following conditions:
it is not the virtual empty queue;
it has at least one packet ready for transmission; and
its QCC and the PCC of its network path are both nonnegative, or the QCC is not smaller than its nonnegative POCT.

At step 225, if the queue of the next timeslot is not the virtual empty queue, the TDM-PC also updates the credit counters and their associated update times for the queue and its path. Then, based upon the credit counters, the TDM-PC determines if the queue of the next timeslot is eligible for service. If the queue of the next timeslot is eligible for service, the TDM-PC scheduler selects the queue of the next timeslot for service at step 225 and then proceeds to step 240. Otherwise, if the queue of the next timeslot is not eligible for service, the TDM-PC moves to step 230. Step 225 is included in the operation of the TDM-PC scheduler to ensure that queues that have previously lost service due to timeslot spillovers by other queues are given every opportunity to recover the lost service.

At step 230, the TDM-PC scheduler checks if a lower-priority queue ready for service is available. The criterion for identification of the lower-priority queue ready for service is not within the scope of the present disclosure and may be derived from various known methods. If a lower-priority queue ready for service is found, the TDM-PC scheduler proceeds to step 245, otherwise it reaches step 235.

At step 235, the TDM-PC scheduler concludes that there is no packet to transmit and returns the control to step 110 of FIG. 3.

At step 240, the QCC and PCC of the selected queue and path are decreased to reflect the transmission of the head packet in the queue. In one embodiment, the credit decrement is equal to the product of the transmission time of the packet to be transmitted by the number N of timeslots that compose the PSS (i.e., PacketTransmissionTime*TotalNumberOfTimeslots). In a second embodiment, the credit decrement is equal to the product of the packet transmission time by the number of allocated timeslots: PacketTransmissionTime*AllocatedTimeslots. In both embodiments, the variable that records the time of the latest credit update is updated for both the QCC and the PCC. Next, the TDM-PC scheduler proceeds to step 245.

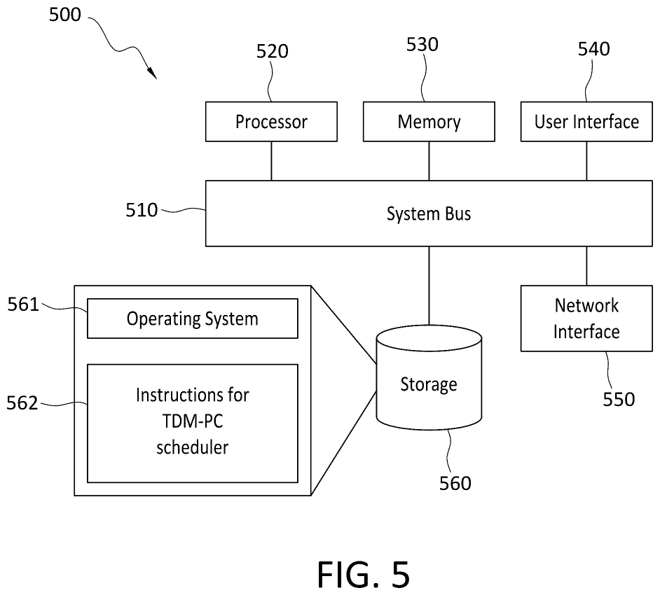

At step 245, the TDM-PC scheduler starts the transmission of the selected packet and proceeds to step 110 of FIG. 5.

FIG. 5 illustrates an example hardware diagram 500 for implementing a TDM-PC scheduler according to some embodiments of the disclosure. The example hardware 500 may be a path computation engine, centralized scheduling controller, local scheduling controller, or link controller. As shown, the device 500 includes a processor 520, memory 530, user interface 540, network interface 550, and storage 560 interconnected via one or more system buses 510. It will be understood that FIG. 5 constitutes, in some respects, an abstraction and that the actual organization of the components of the device 500 may be more complex than illustrated.

The processor 520 may be any hardware device capable of executing instructions stored in memory 530 or storage 560 or otherwise processing data. As such, the processor 520 may include a microprocessor, microcontroller, graphics processing unit (GPU), neural network processor, field programmable gate array (FPGA), application-specific integrated circuit (ASIC), or other similar devices.

The memory 530 may include various memories such as, for example L1, L2, or L3 cache or system memory. As such, the memory 530 may include static random-access memory (SRAM), dynamic RAM (DRAM), flash memory, read only memory (ROM), or other similar memory devices.

The user interface 540 may include one or more devices for enabling communication with a user. For example, the user interface 540 may include a display, a touch interface, a mouse, and/or a keyboard for receiving user commands. In some embodiments, the user interface 540 may include a command line interface or graphical user interface that may be presented to a remote terminal via the network interface 550.

The network interface 550 may include one or more devices for enabling communication with other hardware devices. For example, the network interface 550 may include a network interface card (NIC) configured to communicate according to the Ethernet protocol or other communications protocols, including wireless protocols. Additionally, the network interface 550 may implement a TCP/IP stack for communication according to the TCP/IP protocols. Various alternative or additional hardware or configurations for the network interface 550 will be apparent.

The storage 560 may include one or more machine-readable storage media such as read-only memory (ROM), random-access memory (RAM), magnetic disk storage media, optical storage media, flash-memory devices, or similar storage media. In various embodiments, the storage 560 may store instructions for execution by the processor 520 or data upon which the processor 520 may operate. For example, the storage 560 may store a base operating system 561 for controlling various basic operations of the hardware 500. Storage 562 may include instructions for the TDM-PC scheduler.

It will be apparent that various information described as stored in the storage 560 may be additionally or alternatively stored in the memory 530. In this respect, the memory 530 may also be considered to constitute a “storage device” and the storage 560 may be considered a “memory.” Various other arrangements will be apparent. Further, the memory 530 and storage 560 may both be considered to be “non-transitory machine-readable media.” As used herein, the term “non-transitory” will be understood to exclude transitory signals but to include all forms of storage, including both volatile and non-volatile memories.

The system bus 510 allows communication between the processor 520, memory 530, user interface 540, storage 560, and network interface 550.

While the host device 500 is shown as including one of each described component, the various components may be duplicated in various embodiments. For example, the processor 520 may include multiple microprocessors that are configured to independently execute the methods described herein or are configured to perform steps or subroutines of the methods described herein such that the multiple processors cooperate to achieve the functionality described herein. Further, where the device 500 is implemented in a cloud computing system, the various hardware components may belong to separate physical systems. For example, the processor 520 may include a first processor in a first server and a second processor in a second server.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

It should be appreciated by those skilled in the art that any block diagrams herein represent conceptual views of illustrative hardware embodying the principles of the aspects.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. An apparatus, comprising:
at least one processor; and
at least one memory including a set of instructions,
wherein the set of instructions, when executed by the at least one processor, cause the apparatus to at least:
schedule a transmission of packets in a network from a set of queues using a periodic service sequence including a set of timeslots,
wherein a queue of the set of queues is associated with
one or more respective timeslots from the set of timeslots,
an associated path from a set of paths in the network, and
an associated queue credit,
wherein the associated path of the set of paths is associated with a respective path credit, and
wherein scheduling packet transmissions from the queue is controlled by the associated queue credit and the respective path credit of the associated path.

2. The apparatus of claim 1, wherein an amount of packet transmissions permitted from the queue during the associated one or more respective timeslots is indicated by the respective path credit of the associated path.

3. The apparatus of claim 2, wherein the amount of packet transmissions permitted from the queue during the associated one or more respective timeslots is indicated by the associated queue credit.

4. The apparatus of claim 1, wherein the associated path has a respective path credit counter configured to track the respective path credit of the associated path.

5. The apparatus of claim 4, wherein the queue has a respective queue credit counter configured to track the associated queue credit of the queue.

6. The apparatus of claim 5, wherein the queue comprises a first queue and wherein scheduling the transmission of packets further comprises:
identifying a first timeslot in the periodic service sequence, the first timeslot being associated with the first queue;
increasing the respective path credit counter of the associated path of the first queue;
increasing the respective queue credit counter of the first queue;
determining whether the first queue is eligible for transmission based upon the first queue being real and nonempty and upon the respective path credit counter of the associated path of the first queue and the respective queue credit counter of the first queue; and
based on determining that the first queue is eligible for transmission, scheduling the transmission of packets from the first queue.

7. The apparatus of claim 6, wherein scheduling the transmission of packets further comprises:
determining whether the first queue is a real queue before increasing the respective path credit counter of the associated path of the first queue and before increasing the respective queue credit counter of the first queue; and
identifying a second timeslot in the periodic service sequence and an associated second queue based upon determining that the first queue is not eligible for transmission.

8. The apparatus of claim 6, wherein scheduling the transmission of packets further comprises:
decreasing the respective path credit counter of the associated path of the first queue and decreasing the respective queue credit counter of the first queue based upon determining that the first queue is eligible for transmission.

9. The apparatus of claim 8, wherein decreasing the respective path credit counter of the associated path of the first queue and the respective queue credit counter of the first queue is based upon a packet transmission time.

10. The apparatus of claim 9, wherein decreasing the respective path credit counter of the associated path of the first queue and wherein decreasing the respective queue credit counter of the first queue is further based upon a number of timeslots in the periodic service sequence.

11. The apparatus of claim 6, wherein scheduling the transmission of packets further comprises:
based upon determining that the first queue is not eligible for service:
identifying a second timeslot in the periodic service sequence, the second timeslot being associated with a second queue from the set of queues, wherein the second timeslot is a next timeslot after the first timeslot;
determining whether the second queue is eligible for service; and
based upon determining that the second queue is eligible for transmission, scheduling the transmission of packets from the second queue.

12. The apparatus of claim 11, wherein scheduling the transmission of packets further comprises:
determining whether the second queue is real;
based upon determining that the first queue is not eligible for service and based upon determining that the second queue is real, and before determining whether the second queue is eligible for service:
increasing the path credit counter of the associated path of the second queue; and
increasing the associated queue credit counter of the second queue.

13. The apparatus of claim 12, wherein scheduling the transmission of packets further comprises:
decreasing the path credit counter of the associated path of the second queue and decreasing the associated queue credit counter of the second queue based upon determining that the second queue is eligible for transmission.

14. The apparatus of claim 6, wherein:
increasing the respective path credit counter of the associated path of the first queue is based upon an amount of time since the respective path credit counter of the associated path of the first queue was last updated; and
increasing the associated queue credit counter of the first queue is based upon an amount of time since the associated queue credit counter of the first queue was last updated.

15. The apparatus of claim 14, wherein:
increasing the respective path credit counter of the associated path of the first queue is further based upon a number of timeslots that are allocated to the associated path of the first queue within the periodic service sequence; and
increasing the associated queue credit counter of the first queue is further based upon a number of timeslots that are allocated to the first queue within the periodic service sequence.

16. The apparatus of claim 6, wherein determining whether the first queue is eligible for service further comprises:
determining whether the respective path credit counter of the associated path of the first queue and the associated queue credit counter of the first queue are both nonnegative; or
determining whether the respective queue credit counter of the associated path of the first queue is larger than a path-override credit threshold.

17. The apparatus of claim 6, wherein scheduling the transmission of packets further comprises:
based up determining that the first queue is not eligible for service:
determining whether a second queue associated with a second timeslot of the set of timeslots is eligible for service, wherein the second timeslot is a next timeslot after the first timeslot;
based upon determining that the second queue of the second timeslot is not eligible for service, determining whether a lower-priority queue is ready for service; and
based upon determining that the lower-priority queue is ready for transmission, scheduling the transmission of packets from the lower-priority queue.

18. The apparatus of claim 17, wherein scheduling the transmission of packets further comprises:
eliminating scheduling the transmission of packets, based upon determining that no lower-priority queue is ready for transmission.

19. The apparatus of claim 5, wherein the respective path credit counter of the associated path of the queue and the respective queue credit counter of the queue are initialized based on a time duration of the periodic service sequence.

20. A method, comprising:
initializing a set of path credit counters;
initializing a set of queue credit counters; and
scheduling a transmission of packets in a network from a set of queues using a periodic service sequence including a set of timeslots, wherein the scheduling is based upon the set of path credit counters and the set of queue credit counters,
wherein a queue of the set of queues is associated with
one or more respective timeslots from the set of timeslots,
an associated path from a set of paths in the network, and
an associated queue credit counter of the set of queue credit counters,
wherein the associated path is associated with a respective path credit counter of the set of path credit counters, and
wherein packet transmission from the queue is based upon the respective path credit counter of the associated path and the associated queue credit counter.

21. The method of claim 20, wherein the respective path credit counter of the associated path and the associated queue credit counter are indicative of amounts of transmission permitted from the queue during the one or more respective timeslots.

22. The method of claim 20, wherein the queue comprises a first queue and wherein scheduling the transmission of packets further comprises:
identifying a first timeslot in the periodic service sequence and the first timeslot being associated with the first queue;
increasing the respective path credit counter of the associated path of the first queue;
increasing the associated queue credit counter of the first queue;
determining whether the first queue is eligible for service based upon the respective path credit counter and the associated queue credit counter; and
based on determining that the first queue is eligible for transmission, transmitting a packet from the first queue.
